(19) United States
(12) Patent Application Publication
(10) Pub. No.: US 2005/0240443 A1
(43) Pub. Date: Oct. 27, 2005

(54) Method and system for accepting data related to a patient

(76) Inventors: Ester Salman, Hartsdale, NY (US); Michael R. Liebowitz, New York, NY (US); Inderpal Bhandari, Scarsdale, NY (US)

Correspondence Address: RATNERPRESTIA, P O BOX 980, VALLEY FORGE, PA, 19482-0980, US

(21) Appl. No.: 10/830,656

(22) Filed: Apr. 23, 2004

(51) Int. Cl. G06F 17/60

(52) U.S. Cl. 705/3

(57) ABSTRACT

A method of accepting data related to a patient includes entering data related to the patient into a computer during a session. The method also includes determining, during the session, if the data entered during the session conflicts with other data accessible via the computer using predetermined conflict rules.

### FIELD OF THE INVENTION

The present invention relates generally to medical and patient related data collection methods and, more particularly, to data collection methods that dynamically determine whether data being received conflicts with other data according to predetermined conflict rules.

### BACKGROUND OF THE INVENTION

Medical data related to patients or subjects is typically collected in order to develop treatments for medical conditions. For example, clinical trials are conducted in connection with the development of pharmaceutical products. Typically, a clinical trial involves comparing the performance of the drug under development to that of a placebo when administered to similar groups of patients or subjects. It is highly desirable that data collected during a clinical trial is substantially error-free. In practice, however, error-free data are often not the case and inaccurate data represent a significant cost to the pharmaceutical industry and, ultimately, to the consumer.

Drug companies often attempt to reconcile inconsistencies in the data collected during a clinical trial in the so-called “data cleaning phase” which occurs after the data has been collected, but before the database is locked and before the study blind is broken. Because the data-cleaning phase occurs after the patients or subjects related to the data have departed, it is difficult to reconcile the inconsistencies, often resulting in months of delays while reconciliation attempts are made.

The pharmaceutical industry has attempted to address this problem via the use of “edit checks,” which involve a retrospective computer-based verification of factual information such as time, date, temperature, blood pressure, and the like. But certain inconsistencies in data (e.g., inconsistencies related to the clinical judgment of a doctor) are not addressed by such edit checks. Thus, because many inconsistencies are not retrospectively reconciled, inaccurate data may be accepted as part of the final database. This inaccurate data weakens the study's ability to accurately assess the efficacy of a treatment (e.g., a study compound), potentially resulting in at least one of: (a) additional trials being conducted, (b) considerable delay and expense to the treatment developer, (c) the abandonment of a treatment based on a mistaken belief that it is not useful, or (d) the continuance of a research program based on a mistaken belief that a treatment under study is efficacious when it is not. In the extreme, a potentially effective treatment may be abandoned, or an ineffective treatment may be approved for public use, based on inaccurate data.

In retrieving medical or patient data, for example, during clinical trials, medical rating instruments commonly referred to as standardized “medical rating scales” or “scales” are often used. Medical rating scales are used extensively in clinical trials of medications that treat psychiatric conditions, pain-related conditions, and other medical conditions. A scale typically consists of questions pertaining to a patient, and associated with each question is a pre-defined scale (hence the name), for which the response to the question is a score or rating drawn from that scale. The response is made by a rater, which could be the patient (in the case of a self-rating system) or by a doctor or other assessor (in the case of clinician-rated scales).

Exemplary scales that are used in connection with clinical trials of psychiatric medications include the Liebowitz Social Anxiety Scale (LSAS), the Social Phobia Inventory (SPIN), the Duke Brief Social Phobia Scale (DBSPS), the Subjective Units of Discomfort Scale (SUDS), the Hamilton Anxiety Scale (HAM-A), the Hamilton Depression Scale (HAM-D), the Montgomery-Asberg Depression Rating Scale (MADRS), the Yale-Brown Obsessive-Compulsive Disorder Scale (YBOCS), the Panic Disorder Severity Scale (PDSS), the Clinician Administered Post-Traumatic Stress Disorder Scale (CAPS), the Davidson Trauma Scale (DTS), the Positive and Negative Syndrome Scale (PANSS), and the Clinical Global Impressions Scale (CGI). Exemplary scales used in clinical trials of pain-related medications include the Visual Analog Scale (VAS), the McGill Pain Questionnaire (MPQ), and the Treatment Outcome in Pain Survey (TOPS).

As described above with respect to clinical data in general, there are a number of potential inconsistencies related to scales that can weaken the ability of clinical trials to accurately assess potential treatments (e.g., study compounds). Attempts to retrospectively reconcile such inconsistencies related to medical scales have encountered a number of problems similar to those described above. Thus, it would be desirable to provide a method of accepting medical data that overcomes one or more of the above-described deficiencies.

### SUMMARY OF THE INVENTION

To overcome the shortcomings of conventional methods, a new method of accepting data related to a patient is provided. According to an exemplary embodiment of the present invention, the method includes entering data related to the patient into a computer during a session. The method also includes determining, during the session, if the data entered during the session conflicts with other data accessible via the computer using predetermined conflict rules.

According to another exemplary embodiment of the present invention, a computer readable carrier including computer program instructions for implementing the above-described method of accepting data related to a patient is provided.

According to yet another exemplary embodiment of the present invention, a system for accepting data related to a patient is provided. The system includes a storage unit for receiving data related to the patient through a computer during a session. The system also includes a conflict determination unit for determining, during the session, if the data entered during the session conflicts with other data accessible via the computer using predetermined conflict rules.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a flow diagram illustrating a method of accepting data related to a patient in accordance with an exemplary embodiment of the present invention;

FIG. 2 is a flow diagram illustrating another method of accepting data related to a patient in accordance with another exemplary embodiment of the present invention;

FIG. 3 is a flow diagram illustrating a conflict determination method in accordance with an exemplary embodiment of the present invention;

FIG. 4 is a block diagram of a system for accepting data related to a patient in accordance with an exemplary embodiment of the present invention;

FIG. 5 is a block diagram of another system for accepting data related to a patient in accordance with another exemplary embodiment of the present invention; and

FIG. 6 is an illustration of an interface for submitting information related to a patient in accordance with an exemplary embodiment of the present invention.

### DETAILED DESCRIPTION OF THE INVENTION

In overcoming certain deficiencies of the prior art, the present invention addresses a number of potential patient or medical data inconsistencies. One such inconsistency may occur in connection with rating a single symptom that occurs as a single item on two separate medical rating scales. An example of such a symptom is depressed mood, which occurs on the HAM-D and the HAM-A scale. A related potential inconsistency exists when a symptom (e.g., sleep difficulty) is rated as a single item on one scale (e.g., the HAM-A), but as a plurality of items on another scale (e.g., the HAM-D). Logically, there should be some level of agreement between the two single item ratings for depressed mood, particularly if the ratings are provided at the same patient visit and pertain to how the patient felt over a similar time period. Likewise, there should be some level of agreement between the single item assessment of sleep difficulty and the sum of the plural item assessment of that same function over the same time period. Inconsistencies reflected in lack of agreement tend to indicate that at least one of the symptom assessments is inaccurate.

Another type of inconsistency that can lead to inaccurate data is disagreement between specific symptom measures and global assessments related to overall severity of a condition. For example, the LSAS is a 24-item symptom measure of the severity of social anxiety disorder, and the total on this scale has been designated by the FDA as the primary outcome measure in any pharmaceutical company sponsored trials of this condition. A second major outcome measure is called the Clinical Global Improvement Scale or CGI, which measures both overall severity (the CGI-S) and improvement (or the lack of improvement) during a clinical trial (the CGI-I). Logically, severity as measured by the total LSAS score desirably bears some correlation to severity as measured by the CGI-S. Similarly, change in the LSAS total score over the course of a clinical trial should also be reflected in a change in severity of the CGI-S, and change as measured by the CGI-I. Lack of agreement between these measures can leave data analysts and other medical professionals uncertain about the efficacy of a given treatment or compound.

Yet another type of potential inconsistency is between two global measures. For example, a patient may have a CGI severity rating indicating marked illness at the baseline visit, and a rating of mild illness at the study endpoint. Given this change in severity ratings, the CGI measure of change at study endpoint should logically indicate a certain level of improvement as well. If the CGI measure at the study endpoint indicates no change in severity, an apparent inconsistency exists, thereby raising questions about the validity of one of the two severity ratings, or the change rating.

A related situation may occur in connection with an algorithm that indicates that a patient whose symptom scores decrease by a certain percentage is classified as a treatment responder. Such algorithms are often used, for example, in relation to the HAM-D scale regarding depression and the Panic Disorder Severity Scale (PDSS) regarding panic disorder (see below). Apparent inconsistencies may occur between responder rates determined by such algorithms in connection with symptom scales and responder rates derived from global improvement scales such as the CGI-I. For example, a federally funded multi-center trial compared the drug imipramine (IMI), cognitive behavioral psychotherapy (CBT), pill placebo (PBO), IMI plus CBT, and PBO plus CBT in panic disorder. See D. Barlow et. al., “Cognitive-Behavioral Therapy, Imipramine, or Their Combination for Panic Disorder: A Randomized Controlled Trial,” JAMA 283 (19):2529-36 (2000). Patients were considered responders to a treatment if they were rated at study endpoint as very much improved (a rating of 1) or much improved (a rating of 2) on the CGI-I, or if they showed a 40% or greater decrement on the PDSS, a scale that rates symptoms of panic and related features.

Logically, there should have been some correspondence among these global improvement assessment tools. In this trial, however, for the intent to treat population in the acute treatment phase, the placebo response rates were 21.7% using the PDSS versus 37.5% using the CGI-I; for the acute phase completer sample, the response rates for the placebo group were 38.5% with the PDSS and 64.3% for the CGI. Because the response rates for the other treatments did not vary greatly between the two scales, the differences between the active treatments and placebo varied greatly depending on which measure was used. More specifically, a significant difference resulted using the PDSS but not using the CGI. That is, with one scale the theoretically active treatments proved efficacious, while with the other measure they did not. Whether the differences reflect something clinically important about the treatments or are due to measurement error is not indicated in the study report, presumably because investigators were not aware of this conflict while the data was being collected, and therefore lacked the ability to reconcile the apparent inconsistencies after the data collection was complete.

Thus, a problem in accepting medical data from a patient is that raters (i.e., medical professionals) do not typically look for apparent inconsistencies across symptom measures during a given rating period, between symptom and global ratings during a given rating period, and across symptom and global measures over the course of a study.

As described in greater detail below, the present invention provides for the capture of the reason, rationale, or both underling conflicting or inconsistent data at the time when at least a portion of the data is collected. For example, the underlying justifications may be obtained by alerting a rater (i.e., in an embodiment of the invention related to scales) as to inconsistencies associated with a response at the time of the capture of the response, thereby enabling the rater to change or retain the response. Further, the justification of the rater for such change or retention may also be captured in an audit trail. Thus, the conflicting responses can be reconciled during the data cleaning phase by referring to the accompanying justifications in the audit trail. The issue of after-the-fact reconciliation is thus addressed by the capture of justifications for every conflict that was prevented or allowed to remain in the data.

As such, the methods and systems described identify conflicting medical or patient data (e.g., responses to medical scales) in real-time (i.e., during a patient's visit in a clinical trial), and then provide for the capture of a justification (e.g., from the rater) for retaining or changing the data that conflicts. As described below, certain embodiments of the present invention enable this to be implemented in conjunction with other prompts and conventions that help a rater collect data in a standardized manner.

In accordance with certain exemplary embodiments of the present invention, an effective mechanism of reconciling inconsistencies in the data can be achieved by considering the underlying reasons why those inconsistent elements were introduced in the data. The present invention recognizes that an effective time to accurately determine the underlying reasons for conflicting data is the time when the inconsistency is introduced in the data. By alerting raters as to a potential conflict based on data corresponding to a current response, and requiring that a justification be made before further data is captured, the underlying reason for the conflict is captured accurately.

According to an exemplary embodiment of the present invention, after capture and storage of data (e.g., responses to a plurality of medical scale questionnaires), knowledge of relationships that exist between certain pieces of data are used to determine whether the current data is consistent with previously recorded data. If a potential conflict or inconsistency exists, additional data may not be captured until the rater provides a justification for the inconsistency, or changes the data to negate the inconsistency. One or both of the justification and the changed data are captured and stored.

According to an exemplary embodiment of the present invention, the data (e.g., responses to questions associated with medical scales) may be captured by an electronic data capture (EDC) system, voice recognition system (e.g., IVR), handwritten notes, auditory methods, or other mechanisms to record and capture information. For example, the data may be captured by special-purpose EDC systems that include home diaries, web forms, etc. The knowledge used to determine conflicts may be invoked electronically by using rule bases, knowledge bases, cases, or other programming methods and structures. The conflicts to be resolved may include, for example, conflicts between single responses, or conflicts between a single response and multiple responses. The responses may relate to questions that involve assessments of specific medical aspects of a patient or to questions that involve global assessments of the patient. The responses may relate to, for example, numeric or qualitative assessments.

Certain embodiments of the present invention include prompting a rater with conventions that assist the rater in properly interpreting a question or group of questions, or providing the rater with information that is useful in standardizing the use of the scales. For example, the system may be configured to check for spelling errors, empty data fields, or other missing, incorrect, or incomplete information.

The rater may be made aware of a conflict or inconsistency via electronics, synthesized voice, or other alerting mechanisms. The rater may be the patient in the case of self-assessment, or a medical professional (e.g., a doctor, assessor, clinician, study coordinator, etc.) in the case of conventional assessments.

As used in this document, the term “computer” is intended to mean any of a number of devices including a processor and memory, for example, a handheld computer (e.g., a personal digital assistant), a laptop computer, a personal computer, a computer server, and a mainframe computer.

As used in this document, the term “patient” is intended to mean any party considered in connection with the retrieval of medical or patient data. For example, a patient may be a participant in a clinical trial. A patient may also be an individual providing medical data to be used in connection with the patient outside of a clinical study or trial.

As used in this document, the term “medical professional” is intended to mean any of a number of persons employed in the medical field. For example, a medical professional may refer to a doctor, a clinical study coordinator, a clinical study data analyst, etc.

Preferred features of embodiments of this invention will now be described with reference to the figures. It will be appreciated that the spirit and scope of the invention are not limited to the embodiments selected for illustration. It is contemplated that any of the configurations described can be modified within the scope of this invention.

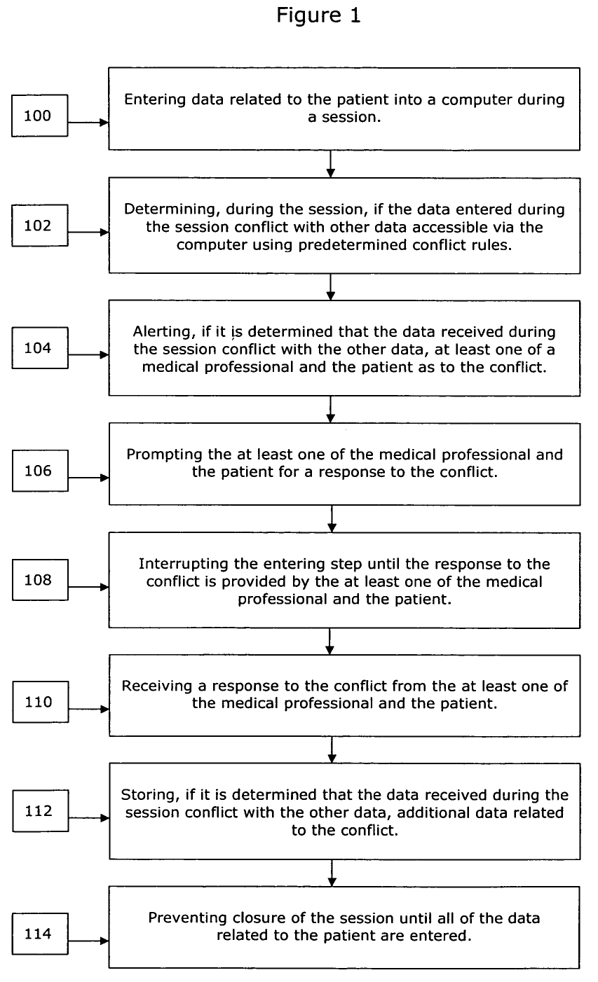

FIG. 1 is a flow diagram illustrating a method of accepting data related to a patient in accordance with an exemplary embodiment of the present invention. At step 100, data related to a patient are entered into a computer during a session. At step 102, a determination is made, during the session, as to whether the data entered during the session conflict with other data accessible via the computer using predetermined conflict rules. At step 104, if it is determined that the data received during the session conflict with the other data, at least one of a medical professional and the patient is alerted as to the conflict. At step 106, the at least one of the medical professional and the patient is prompted for a response to the conflict. At step 108, the entering step is interrupted until the response to the conflict is provided by the at least one of the medical professional and the patient. At step 110, a response to the conflict is received from the at least one of the medical professional and the patient. At step 112, if it is determined that the data received during the session conflict with the other data, additional data related to the conflict are stored in memory. For example, such data may be stored for use as an audit trail related to the conflict. At step 114, closure of the session is prevented until all of the data related to the patient are entered during the entering step. By preventing closure of the session until all of the data are entered, a more complete set of data (e.g., a set of responses to a questionnaire) is likely to be provided.

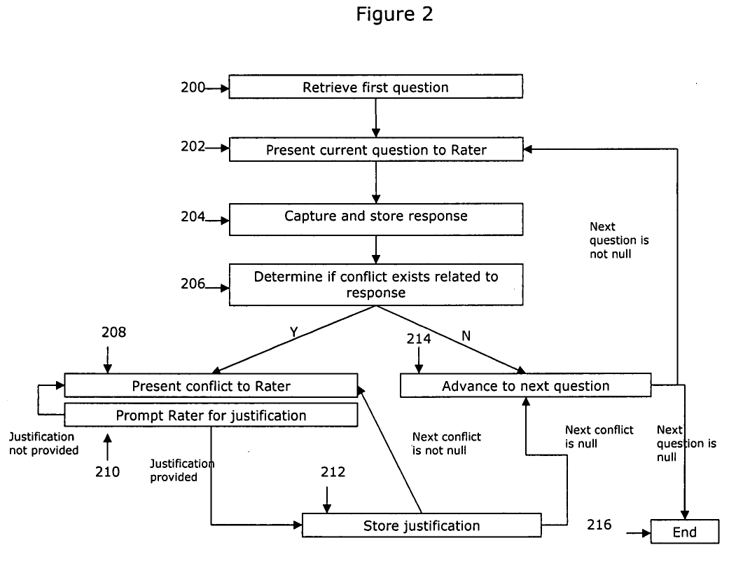

FIG. 2 is a flow diagram illustrating a method of accepting data related to a patient, for example, in connection with one or more medical scales. At step 200, a first question (e.g., a first question of a medical scale questionnaire) is retrieved (e.g., from a data file or a database) and, at step 202, the question is presented to a rater (e.g., a patient or a medical professional obtaining data from a patient). At step 204, a response to the question is captured and stored. At step 206, a determination is made as to whether the response is consistent with previously recorded data. For example, this determination may be made using knowledge of how questions in a plurality of scales are related, as will be explained in greater detail below.

If the result of step 206 is “no,” then the process proceeds to step 214 where an advance is made to the next question unless there is no next question. If there is a next question (i.e., the next question is not null), the process returns to step 202 where the next question is presented to the rater. If there is no next question (i.e., the next question is null), the process proceeds to the end of the process at step 216.

If the result of step 206 is “yes,” then the process proceeds to step 208 where the conflict determined to exist at step 206 is presented to the rater. The process proceeds from step 208 to step 210, where the rater is prompted for a justification to the conflict. If no justification is provided at step 210, the conflict continues to be presented to the rater. If a justification is provided at step 210, the process proceeds to step 212 where the justification provided is stored (e.g., in memory of a computer).

In the exemplary embodiment of the present invention illustrated in FIG. 2, the justification may be a reason for the conflict. Alternatively, the justification provided may actually be that at least one part of the conflicting data (e.g., the present response or the other data previously stored) is changed.

If the conflict is cleared by the storage of the justification at step 212 (i.e., the conflict is null), then the process proceeds to step 214 where an advance is made to the next question unless there is no next question, as described above. If the conflict is not cleared by the storage of the justification at step 212 (i.e., the conflict is not null, and still exists), then the process proceeds back to step 208, where the conflict is again presented to the rater.

Thus, through the process illustrated in FIG. 2, each of the questions is presented to the rater, and a response is obtained. The response is captured, stored, and checked for a conflict. Once a conflict is determined to exist (e.g., the response is inconsistent with other previously stored data), the conflict is presented or displayed to the rater, and an adequate justification for the conflict is provided before the process continues. The justification is stored, thereby creating an audit trail. The process ends at step 216 when all of the questions have been answered (e.g., all of the questions in a medical scale) and any conflicts have been justified.

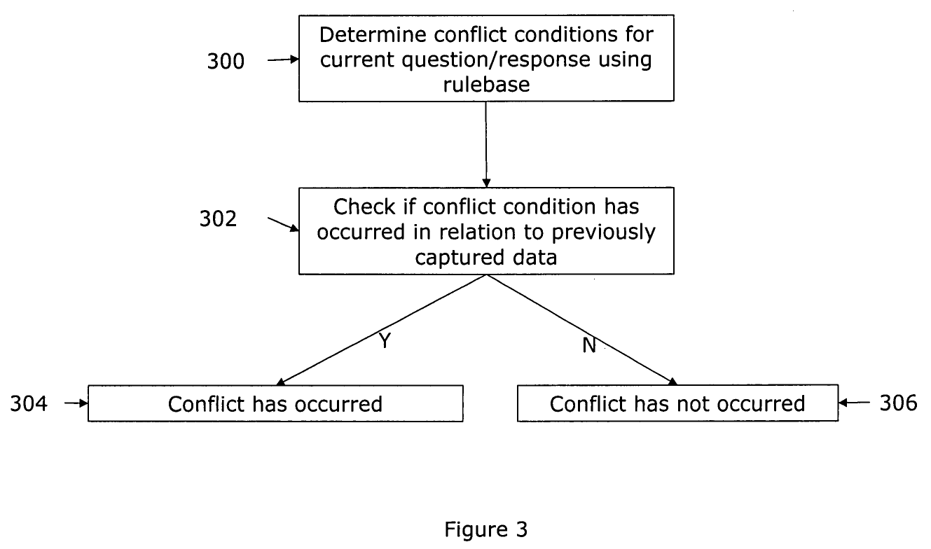

FIG. 3 is a flow diagram illustrating an exemplary set of steps for determining if a conflict exists related to a question or a corresponding response. According to an exemplary embodiment of the present invention, the steps illustrated in FIG. 3 correspond to step 206 of the process illustrated in FIG. 2. At step 300, potential conflict conditions related to the present question or the current response are retrieved using a rulebase, as described below. At step 302, using the present response, the conflict conditions retrieved at step 300 are checked against previously captured data. If a conflict condition has occurred with respect to the previously captured data at step 302, then a conflict is identified at step 304. If no conflict condition has occurred with respect to the previously captured data at step 302, then the absence of a conflict is identified at step 306.

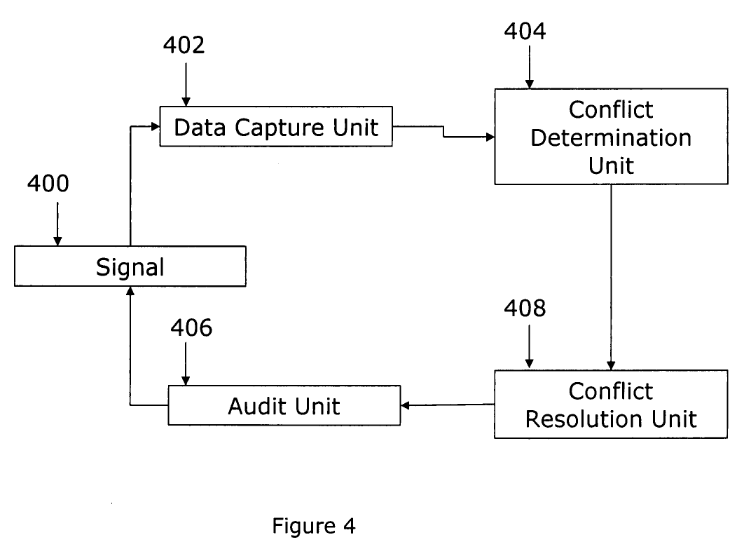

FIG. 4 is a block diagram illustration of a system for accepting data related to a patient in accordance with an exemplary embodiment of the present invention. In the exemplary system illustrated in FIG. 4, in order for the system to accept data related to a patient, a signal 400 is provided. For example, signal 400 may be a logic-based signal in software or may be a switched hardware signal. By controlling signal 400, the system controls whether data may be accepted. As such, in the case of a conflict (i.e., inconsistent data), signal 400 may be low (e.g., a zero value, an open connection, etc.) so that no additional data may be presently accepted. Alternatively, if there is no present conflict (e.g., a justification has been provided for any existing conflict), signal 400 may be high (e.g., a one value, a closed connection, etc.) so that data may be accepted.

The system includes data capture unit 402 for capturing and storing responses by a rater for a plurality of questions (e.g., questions related to a medical scale). After a response is captured by data capture unit 402, conflict determination unit 404 determines if a conflict exists with respect to the response. For example, conflict determination unit 404 possesses knowledge of how certain pieces of data (e.g., data related to questions in a plurality of medical scales) are related and determines whether a response is consistent or inconsistent with other previously captured data related to the present response and question. The other previously captured data may be related to the particular patient or, in some circumstances, other patients.

Conflict resolution unit 408, which is responsive to conflict determination unit 404, acts as an interface for displaying the responses that have been determined to be inconsistent, and enables the user/rater to change the conflicting data (e.g., the present response) or to provide a justification related to the conflict. Audit unit 406, which is responsive to conflict resolution unit 408, records changes to or retention of the present response, and captures a justification provided by the rater for the change or retention. This process of accepting data at data capture unit 402 and determining if a conflict exists at conflict determination unit 404 continues so long as signal 400 is high. Signal 400 may stop or continue electronic capture of the data, however, responsive to the audit trail provided by audit unit 406, thereby requiring the rater to resolve the conflict at conflict resolution unit 408 in order for the data capture to continue.

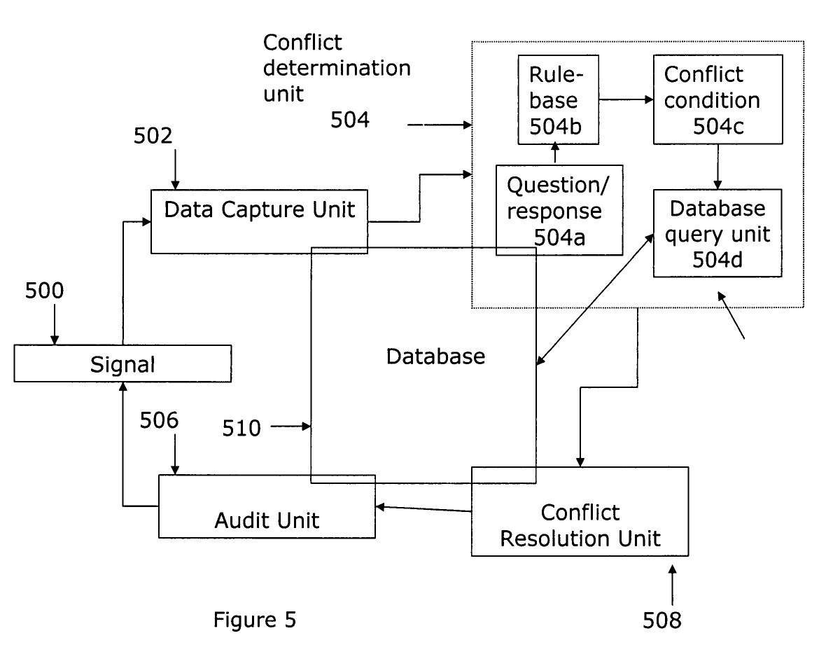

FIG. 5 is a block diagram illustration of a system for accepting data related to a patient that is similar in certain respects to the system illustrated in FIG. 4. Signal 500, data capture unit 502, conflict determination unit 504, conflict resolution unit 508, and audit unit 506 provide similar functions to the corresponding elements of the system illustrated in FIG. 4. FIG. 5 also illustrates database 510. After capturing data (e.g., responses to medical scale questions), data capture unit 502 stores the captured data in database 510. In an embodiment for which the data captured include responses to medical scale questions, the present response and corresponding question (e.g., question/response pair 504a) are used in connection with rulebase 504b in order to determine conflict condition 504c related to the data. Of course, conflict condition 504c may be a number of potential conflict conditions related to the captured data. Database query unit 504d compares conflict condition 504c to other data stored in database 510 to determine if a conflict exists.

If a conflict exists, the conflict is resolved by conflict resolution unit 508 through verification with database 510. For example, if the response leading to the conflict is changed by the user/rater, the changed response is stored and verified for a potential conflict using database 510. Alternatively, if the other data in database 510 leading to the conflict are changed, the changed other data are stored and again verified for a potential conflict using database 510. Further still, if a justification for the conflict is provided, the justification is stored and verified as an adequate justification using database 510.

The resolution of the conflict (e.g., the changed response, the changed other data, the justification provided, etc.) is stored as part of an audit trail by audit unit 506 in connection with database 510. Although database 510 is illustrated as a single database in FIG. 5, database 510 may be any of a number of data storage units in any of a number of distinct locations.

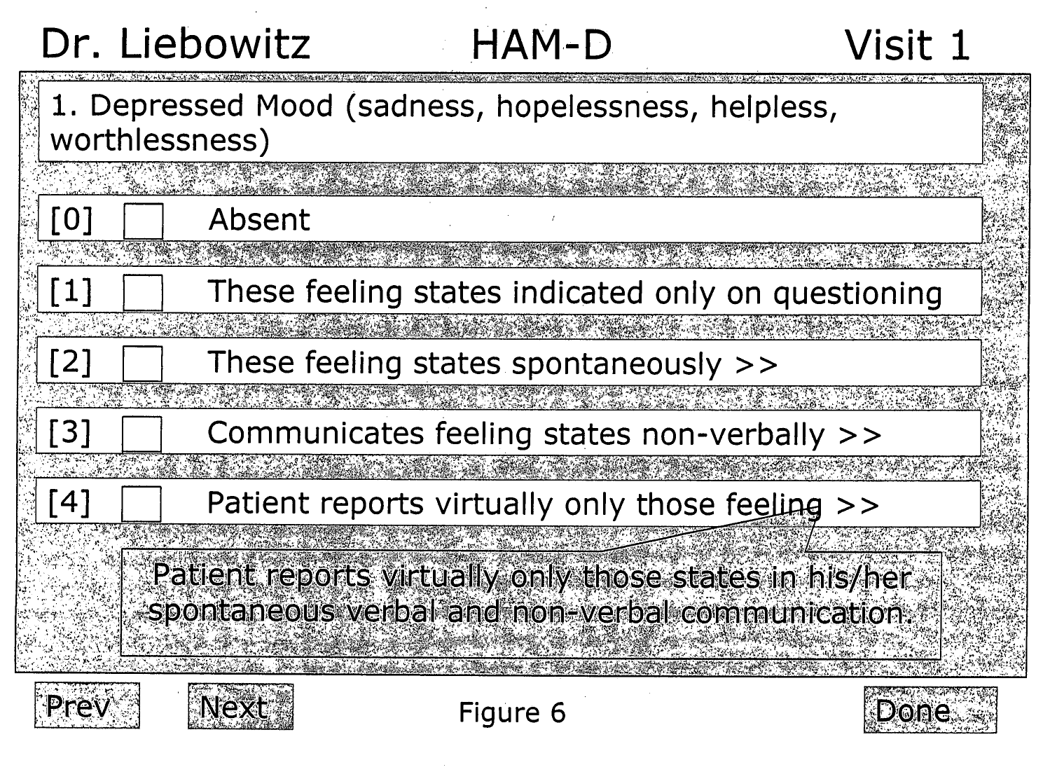

FIG. 6 is an exemplary illustration of an interface for submitting information related to a patient, for example, through a portable computer display. The interface may be viewed as a screen shot of the process for obtaining data and responses to medical scale questions. The interface indicates that the treating medical professional is Dr. Liebowitz, that the medical scale under analysis is the HAM-D scale (the Hamilton Depression scale), and that this is the patient's first visit. The screen of the HAM-D scale illustrated in FIG. 6 relates to “Depressed Mood.” The rater is to indicate, through the interface, which of conditions 0-4 the patient exhibits. For example, if the patient does not have a depressed mood, then the rater would select condition 0. Conditions 2-4 include “>>” marks at the end of the text, indicating that the text could not all fit on the interface screen. In FIG. 6, the complete text of condition 4 is illustrated in a “balloon.” After the rater completes the question related to Depressed Mood, the rater selects the “Done” button at the lower right portion of the interface. The rater may also cycle through the questions using the “Prev” and “Next” buttons at the lower left portion of the interface.

Referring now to the methods and systems illustrated in FIGS. 1-5, many different implementations are contemplated including, for example, fully automated or semi-automated implementations. Further, both centrally and distributed process implementations are contemplated. For the sake of brevity, a fully automated, centrally processed implementation is the primary emphasis of the following description. This exemplary implementation centers around electronic data capture (EDC).

An EDC-based implementation of the present invention may be implemented on a computer, for example, a hand-held computer such as that available from Palm Corporation of Milpitas, Calif.; the Dana unit available from AlphaSmart Corporation of Los Gatos, Calif.; or the YUII unit available from Microsoft Corporation of Seattle, Wash. In such an implementation, one or more of the blocks illustrated in FIG. 4 represents a module of a computer program (e.g., written using a programming environment such as CodeWarrior from the Metrowerks Corporation of Austin, Tex.) that implements the logic embodied by one or more of the flow diagrams illustrated in FIGS. 1-3. Thus, all or a portion of the logical blocks in FIGS. 4 and 5 and the steps illustrated in FIGS. 1-3 may be embodied in a computer program that resides and executes on a computer such as a handheld computer.

Consider the implementation, in software, of certain of the method steps illustrated in FIGS. 1-3 and logic blocks illustrated in FIGS. 4 and 5. For example, in embodiments using medical scales for prompting data responses related to a patient, data capture unit 402 in FIG. 4 may be a computer program developed to implement a survey questionnaire (e.g., a medical scale questionnaire) on a computer such as a handheld computer. Such a program may be configured to cycle through the questions in one or more questionnaires in a pre-determined sequence, for example, presenting one question at a time to the user/rater. This presentation of questions could be accomplished, for example, through a repeat programming construct, such as a repeat-while or a repeat-until construct.

Certain questions from a questionnaire may be quite lengthy, and may not fit on small screens of certain handheld computers. The computer program implemented on the computer may utilize a programming technique to display only partial text on a screen while providing the user with the capability to display the entire text in a separate screen, as shown in FIG. 6.

Consider the implementation of the steps and logic blocks related to recording a change in data or recording a justification for a conflict. For example, this function may be implemented by prompting the user for input and then storing the input in the memory of a handheld computer. A user interface structure such as a drop-down list or a keypad presentation may be used to capture input from the user. Similarly, storing the input may be accomplished using a database structure with records that have distinct fields for patient data, medical scale questionnaire data, question data, response-to-question data, justification data associated with the response-to-question, the date, site location, and other administrative details. The logic to determine if the rater has provided a justification can be implemented by programming constructs such as repeat-while and if-then-else constructs.

A particularly interesting aspect of the present invention relates to the determination as to whether a present response is inconsistent or conflicts with other previously stored data. This feature is illustrated as step 102 in FIG. 1, step 206 in FIG. 2, steps 300-306 in FIG. 3, conflict determination unit 404 in FIG. 4, and conflict determination unit 504 in FIG. 5. In providing for this feature in certain embodiments, a computer program can be embedded with knowledge of related questions and responses (e.g., that appear in a plurality of medical scales), and logic related to how the program can invoke the knowledge to detect conflicting responses or inconsistencies in connection with a present response.

By carefully inspecting the questions in a plurality of medical scales, relationships that exist between questions in a plurality of scales may be identified, and the relationships may be exploited to determine potential inconsistencies. For example, the HAM-A scale and the HAM-D scale both include questions pertaining to sleep difficulty. Therefore, these questions are related, and it follows that if the response for a question in one scale is that the patient has a problem with sleep while the response to the question in the other scale is that the patient sleeps without problem, there is an apparent conflict or inconsistency. An important aspect of the present invention is that such knowledge can be encoded in a form that can be applied substantially immediately when a response to a question is received from the rater. One implementation is to encode that knowledge as a set of rules to identify inconsistent or conflicting responses that can be invoked electronically by a computer program. The knowledge used to determine conflicts may be invoked electronically using rule bases, knowledge bases, cases, or other equivalent programming methods and structures.

For example, such knowledge can be resident in a computer program in the form of a rule as follows: If and only if (iff) Response to Scale-A, Question number 4 in the range {0,1,2}, then Response to Scale-B, Question Number 6 must be in the range {0,1,2}. This example assumes that Scales A and B involve numeric ratings in order of increasing severity. For example, 0,1,2 would be used to indicate a problem of low severity while 3,4,5 would indicate high severity. Note that a similar rule could be devised if qualitative ratings (such as High and Low) were being used instead of numeric ratings. Also noteworthy is that, although this example is described in terms of the bi-directional iff, the example could also have utilized the uni-directional if. In addition, although this example uses a simple scheme to identify rules by scale identity and question number, other factors could be added to make the identification of rules more complex.

The above rules compare a single response to two different questions. In some cases, however, it is desirable to compare a single response with multiple responses. For example, a rule could be: If Response to Scale-A, Question number 5 is in the range {0,1,2}, then Responses to Scale-B, Question Numbers 8 and 9 must both be in the range {0,1,2}.

Although the above rules suggest a specific condition that is being rated from 0 to 5 in the responses being compared, in some cases it is desirable to compare responses to specific aspects being evaluated in connection with a patient with a global assessment of the patient. In other cases, it is desirable to compare responses to two or more global assessments of the patient.

For example, in connection with patients being tested regarding social anxiety disorder, comparisons of CGI-S scores and LSAS totals suggest the following correspondence: CGI-S of 1 (not ill) corresponds with LSAS total of 0-25; CGI-S of 2 (borderline ill) corresponds with LSAS total of 26-35; CGI-S of 3 (mildly ill) corresponds with LSAS total of 36-50; CGI-S of 4 (moderately ill) corresponds with LSAS total of 51-65; CGI-S of 5 (markedly ill) corresponds with LSAS total of 66-80; CGI-S of 6 (severely ill) corresponds with LSAS total of 81-95; and CGI-S of 7 (among the most ill) corresponds with LSAS total of 96-144. Ratings that fell outside this correspondence would not automatically be assumed to be incorrect, because the CGI-S and LSAS scales are meant to be independent and a variety of factors could explain their occurrence. The steps of drawing a rater's attention to the possible inconsistency and prompting the rater for an explanation of the possible inconsistency allows, however, for correction of erroneous ratings, production of a justification for ratings that the rater retained or changed, or both—thereby producing an audit trail.

Similar correspondences may be determined between symptom measures of, for example, depression (HAM-D, Montgomery-Asberg Depression Rating Scale (MADRS)) or generalized anxiety (HAM-A) with global severity ratings determined by CGI-S. Such correspondences may be derived empirically. For example, by reviewing existing databases the upper and lower bounds for the 95% confidence intervals for symptom scores that correspond to the severity levels of the CGI may be determined. Likewise, correspondences between symptom measures and other global severity measures may be designed to rate the same phenomena.

As provided above, specific symptom measures may also be correlated with a global assessment of change. For example, in a panic disorder study for which a given percent decrease on the PDSS is used as one method of identifying treatment responders, a CGI-I of 1 (very much improved) or 2 (much improved) may also be used for the same purpose. Ratings for patients being rated as responders by one measure and not the other would be queried in real time to highlight a possible inconsistency, giving the rater the opportunity to reexamine his or her ratings of the two measures and either adjust or leave the ratings unchanged, with an explanation also being provided. A similar approach could be used in correlating the HAM-D and MADRS for depression with the HAM-A for generalized anxiety disorder, where a percentage decrease prospectively determined to indicate responder status could be matched against a designation of responder status of a CGI global improvement rating. For example, the rule bases regarding the percentage decrease on a given scale that should correspond to responder status can be taken from conventions already established in the field or, where such conventions do not exist, they may be derived from examination of existing databases in a manner similar to that suggested above for the CGI-S. An example of an already established convention pertains to the HAM-D, where a subject exhibiting a 50% or greater decrease in total score over the course of an acute trial is considered a responder.

Global measures of severity may also be correlated with global assessments of change. The CGI-S measures global severity at a given point in time, while the CGI-I measures change (e.g., improvement, no change, or worsening) from the beginning of the trial until the time of the rating. Logically, there should be some correlation between change in the pre- and post-treatment severity measures and the overall assessment of change at the study endpoint. But this is often not the case. For example, a logical rule base may provide that (a) no change in severity scores should correspond to no change on the improvement measure, (b) a 2 point change up or down on the severity score should correspond to a much improved or much worsened status on the CGI-I, and (c) a 3 or more point change in severity should correspond to a very much improved or very much worsened status on the CGI-I. As before, scores falling outside these correspondences would not automatically be considered invalid; rather, they may simply prompt the rater to further reflect on his or her ratings to be sure that the rater's best estimate is captured, using all available data. The ratings for the current period could then be kept as before, or altered, in either case accompanied by an explanation to be captured in the audit trail

Once these rules for conflicts and inconsistencies are devised, the determination as to whether a present response creates a conflict or inconsistency may be accomplished, for example, using a rule-based programming paradigm or case-based reasoning. For example, such programming paradigms may implement a look-up table that enables one to find which question and response pairs are related by certain rules. Such an implementation is illustrated and described above with reference to FIG. 5.

As described above, FIG. 5 illustrates that a present question-response pair 504a, having been completed by the rater, is used in connection with rule base 504b to determine the conditions that define a conflict or inconsistency (i.e., conflict condition 504c). These conditions are then checked against database 510, which stores the data previously captured to determine if a conflict exists. For example, database 510 may have a database structure including records that have distinct fields for patient data, questionnaire data, question data, response data, the date, site location, and other administrative details. An exemplary rule base is presented below along with an instance of how the audit trail could be encoded and captured.

Rule-Base for LSAS to CGI: (LSAS Range=0-144)
CGI-S=1; LSAS=0-25
CGI-S=2; LSAS=26-35
CGI-S=3; LSAS=36-50
CGI-S=4; LSAS=51-65
CGI-S=5; LSAS=66-80
CGI-S=6; LSAS=81-95
CGI-S=7; LSAS=96-144
   Rule-Base for Subjective Units of Discomfort Scale (SUDS) to CGI Severity: (SUDS Range=0-100)
CGI-S=1; SUDS=Mean of 0-20
CGI-S=2; SUDS=Mean of 21-35
CGI-S=3; SUDS=Mean of 36-50
CGI-S=4; SUDS=Mean of 51-65
CGI-S=5; SUDS=Mean of 66-80
CGI-S=6; SUDS=Mean of 81-90
CGI-S=7; SUDS=Mean of 91-100

The SUDS ratings are used to rate the level of discomfort a patient with Social Anxiety Disorder experiences during a controlled laboratory-based challenge that simulates a real life feared situation (e.g., speaking in public, socializing at a party, etc.). A total of 12 SUDS ratings are typically collected during an active study challenge visit.

Rule-Base for SUDS to CGI Change Score:
CGI-C=1 (Very Much Improved); Mean Decreased >30 Points
CGI-C=2 (Much Improved); Mean Decreased 21 to 30 Points
CGI-C=3 (Minimally Improved); Mean Decreased 11-20 Points
CGI-C=4 (No Change); Mean Changed −10 to 10 Points
CGI-C=5 (Minimally Worse); Mean Increased 11 to 20
CGI-C=6 (Much Worse); Mean Increased 21-30 Points
CGI-C=7 (Very Much Worse); Mean Increased >30 Points

Audit Trail Coding

Rule-base violations for which the rater wishes to change an answer would include, for example, a drop-down field where the rater can select a response that indicates the reason for the change, such as:
01—Data Entry Error
02—New Information Obtained (i.e., information not previously available)
03—Clarification of Information (i.e., upon further questioning different information obtained)
04—Monitor Request

Rule-base violations for which the rater wishes not to change an answer would include, for example, a text/comment field where the rater can enter a justification.

As described above, in the event of a data conflict or inconsistency, a rater may be given the ability to change the conflicting data (e.g., either one or both of the present response and other responses stored in a database may be changed). In the case of a rule that relates to multiple responses, the rater could potentially change several responses at the present visit. Although this is not a limitation of the present invention, from a practical and regulatory standpoint the rater may only be permitted to change responses occurring at the present visit. With regard to capturing and storing the changes made by the user, responses can be stored and retrieved from a database via the audit trail. To enable the rater to change responses, a record that was captured previously is re-captured and the fields that have changed are re-stored in the database.

Because a plurality of medical scales define and structure a finite set of inputs to be solicited from the rater, voice recognition (e.g., IVR) and alternative systems may be appropriately used for the data capture implementation. In other embodiments of the present invention, the responses may be captured by special-purpose EDC systems that include home dairies, web forms, etc. In such an embodiment, the sub-logic or sub-modules described with respect to FIGS. 1-5 may be used in conjunction with the logic and modules of a special-purpose EDC system.

The capture of responses, determination of conflicts, and capture of justifications may involve a computer system that is centrally located or a system that is distributed geographically. For instance, a drug manufacturer could choose to implement the data capture at a first location, while connecting to another location (e.g., over a fast broadband link) for implementation of the other logic blocks. In an EDC-based implementation, the database could be uploaded periodically to a server computer that could be located at a central facility. For instance, a palm pilot handheld computer enables a user to “hot sync” information to a desktop computer (e.g., a server computer) using, for example, infra-red communication.

Additional features may be incorporated into certain embodiments of the present invention, as desired by the user. For example, the method may include prompting the rater with conventions that assist in properly interpreting a question or group of questions, or providing similar useful information for standardizing the use of the scales. Further, if a question has been missed, the rater may be prompted to complete the missing field or fields before the data capture process continues. The rater may be made aware of a conflict by using electronics, synthesized voice, or other mechanisms. The justification of the rater may be recorded by electronics, voice recognition, handwritten notes, or other mechanisms to record information.

In various exemplary embodiments of the present invention, the system and methods described herein are fully functional and operational without an Internet connection or even a direct power supply connection. In such embodiments, all of the information (e.g., algorithms, data structures including previously entered data, predetermined conflict rules, etc.) used to operate the system (and carry out the methods) are contained on a portable computer. Thus, a fully portable system is provided, which may be highly desirable in certain situations. For example, certain patients (e.g., patients having anxiety-related disorders) may prefer to have a session with a medical professional in a non-traditional setting. Such settings may include the patient's home, a bus/train, a public place, etc. A fully portable system is highly desirable because such patients desire to have a session in a non-traditional setting may be accommodated.

Through the various exemplary embodiments provided above, because conflicting or inconsistent data are resolved dynamically, the data provided during the cleaning phase of a clinical trial is substantially more accurate.

Although the present invention has been described primarily by reference to medical scales and clinical trials, it is not limited to such scales and trials. The methods and systems disclosed are applicable to any of a number of types of medical and patient data. Although the present invention has been described in terms of a method or system for accepting medical or patient data, it is contemplated that the invention could be implemented entirely (or in part) through software on a computer-readable carrier such as a magnetic or optical storage medium, or an auto frequency carrier or a radio frequency carrier.

Although the invention is illustrated and described above with reference to specific embodiments, the invention is not intended to be limited to the details shown. Rather, various modifications may be made in the details within the scope and range of equivalents of the claims and without departing from the invention.

1. A method of accepting data related to a patient, the method comprising the steps of:
entering data related to the patient into a computer during a session; and
determining, during the session, if the data entered during the session conflicts with other data accessible via the computer using predetermined conflict rules.

2. The method of claim 1 wherein said determining step includes determining if the data entered during the session conflicts with other data received during the session.

3. The method of claim 1 wherein said determining step includes determining if the data entered during the session conflicts with other data related to the patient.

4. The method of claim 1 wherein said determining step includes determining if the data entered during the session conflicts with other data received during another session.

5. The method of claim 1 wherein said entering step includes entering data related to a medical condition, and said determining step includes determining if the data entered during the session conflicts with other data related to the medical condition.

6. The method of claim 1 wherein said entering step includes entering data related to a medical condition, and said determining step includes determining if the data entered during the session conflicts with other data related to another medical condition.

7. The method of claim 1 wherein said entering step includes entering the data related to the medical condition into a portable computer, and said determining step includes determining if the data entered during the session conflicts with the other data using the portable computer.

8. The method of claim 1 further comprising the step of:
alerting, if it is determined that the data received during the session conflicts with the other data, at least one of a medical professional or the patient as to the conflict.

9. The method of claim 8 further comprising the step of:
prompting the at least one of a medical professional or the patient for a response to the conflict.

10. The method of claim 9 further comprising the step of:
receiving a response to the conflict from the at least one of a medical professional or the patient, the response including a change to at least one of the data entered during the session or the other data.

11. The method of claim 9 further comprising the step of:
receiving a response to the conflict from the at least one of a medical professional or the patient, the response including a justification for the conflict.

12. The method of claim 9 further comprising the step of:
interrupting said entering step until the response to the conflict is provided by the at least one of a medical professional and the patient.

13. The method of claim 1 wherein said entering step includes entering the data in response to at least one medical scale questionnaire.

14. The method of claim 1 further comprising the step of:
preventing closure of the session until all of the data related to the patient are entered during said entering step.

15. The method of claim 1 further comprising the step of:
storing, if it is determined that the data received during the session conflict with the other data, additional data related to the conflict.

16. A computer-readable carrier including computer program instructions for implementing a method of accepting data related to a patient, the method comprising the steps of:
entering data related to the patient into a computer during a session; and
determining, during the session, if the data entered during the session conflict with other data accessible via the computer using predetermined conflict rules.

17. A system for accepting data related to a patient, the system comprising:
a storage unit for receiving data related to the patient through a computer during a session; and
a conflict determination unit for determining, during the session, if the data entered during the session conflict with other data accessible via the computer using predetermined conflict rules.

18. The system of claim 17 wherein said conflict determination unit determines if the data entered during the session conflict with other data received during the session.

19. The system of claim 17 wherein said conflict determination unit determines if the data entered during the session conflict with other data related to the patient.

20. The system of claim 17 wherein said conflict determination unit determines if the data entered during the session conflict with other data received during another session.

21. The system of claim 17 wherein said storage unit receives data related to a medical condition, and said conflict determination unit determines if the data entered during the session conflict with other data related to the medical condition.

22. The system of claim 17 wherein said storage unit receives data related to a medical condition, and said conflict determination unit determines if the data entered during the session conflict with other data related to another medical condition.

23. The system of claim 17 wherein said storage unit receives the data related to the medical condition through a portable computer, and said conflict determination unit determines if the data entered during the session conflict with the other data using the portable computer.

24. The system of claim 17 additionally comprising:
an interface for alerting, if it is determined that the data received during the session conflict with the other data, at least one of a medical professional or the patient as to the conflict.

25. The system of claim 24 wherein said interface prompts the at least one of a medical professional or the patient for a response to the conflict.

26. The system of claim 25 additionally comprising:
a conflict resolution unit for receiving a response to the conflict from the at least one of a medical professional or the patient, the response including a change to at least one of the data entered during the session or the other data.

27. The system of claim 25 additionally comprising:
a conflict resolution unit for receiving a response to the conflict from the at least one of a medical professional or the patient, the response including a justification for the conflict.

28. The system of claim 25 wherein the system interrupts the reception of data by said storage unit until the response to the conflict is provided by the at least one of a medical professional or the patient.

29. The system of claim 17 wherein said storage unit receives the data in response to at least one medical scale questionnaire.

30. The system of claim 17 additionally comprising:
an interface for preventing closure of the session until all of the data related to the patient are entered into the storage unit.

31. The system of claim 17 additionally comprising:
an audit unit for storing, if it is determined that the data received during the session conflict with the other data, additional data related to the conflict.
